(19) United States
(12) Patent Application Publication
(10) Pub. No.: US 2026/0094046 A1
(43) Pub. Date: Apr. 2, 2026

(54) EDGE DEVICE ANOMALY SELF-ANALYSIS AND RESOLUTION USING A SELF-ORGANIZING INFRASTRUCTURE SYSTEM

(71) Applicant: Dell Products L.P., Round Rock, TX (US)

(72) Inventors: DEEPAGANESH PAULRAJ, Bangalore (IN); DALE WANG, Hayward, CA (US); MIN GONG, Shanghai (CN); ASHOK NARAYANAN POTTI, Bangalore (IN)

(21) Appl. No.: 18/899,075

(22) Filed: Sep. 27, 2024

(51) Int. Cl. G06N 20/00

(52) U.S. Cl. CPC G06N 20/00

(57) ABSTRACT

Methods and systems for managing anomaly analysis and resolution of a data processing system are disclosed. In particular, a self-organized infrastructure system may be configured such that data processing systems within a computer and/or computing infrastructure may be able to manage their own anomaly analysis and resolution without the need for relying on or interference by a central processing entity.

### FIELD

Embodiments disclosed herein relate generally to management data processing systems. More particularly, embodiments disclosed herein relate to systems and methods for managing anomaly analysis and resolution in a data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with one or more embodiments disclosed herein.

FIG. 2 shows a data flow diagram in accordance with one or more embodiments disclosed herein.

FIG. 3 shows a flow chart in accordance with one or more embodiments disclosed herein.

FIG. 4 shows a block diagram illustrating a data processing system in accordance with one or more embodiments disclosed herein.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems. In particular, in today’s information technology (IT) landscape, a customer’s applications and data may be located at infrastructures at the edge, on-premise, or in the cloud. The complexities of such infrastructures are also continuously increasing. Systems often encompass numerous nodes (e.g., servers, data processing systems implemented using computing devices, devices with computational and storage capabilities, or the like), each generating diverse data, facing distinct issues, and possessing varying resources.

Nodes configured as edge devices (e.g., located at the edge of such infrastructures) are usually not provided with enough computational resources (e.g., computing resources such as memory, processing capabilities, or the like) to analyze and resolve their own anomalies. Data from these edge devices are sent to a centralized processing entity (e.g., a cloud-based server or the like) for handling and analysis.

For example, telemetry and day-to-day operations related data from these edge devices may be gathered and sent to such a centralized processing entity to determine whether an edge device may experience a potential failture (e.g., a predicted future failure). In particular, such centralized processing entities are configured to handle the heavy lifting of data processing, model training, system deployment, and even inference generation.

However, such processing by a centralized processing entity has several limitations, including the necessity of transferring data from the edge device to the centralized processing entity. Such data transfers can be easily, and negatively, impacted by poor network connectivity, packet losses during transfer, expensive data transmission costs, and other such limitations.

As such, while use of such centralized processing entity (or entities) simplifies management and scales efficiently under ideal network conditions, it also introduces significant drawbacks and limitations such as: high latency due to data transmission lines; increased costs associated with data transfers; vulnerability to network disruptions; inefficiency in utilizing computational power available at the edge (e.g., using the edge devices); or the like.

To overcome the above-discussed limitations, embodiments disclosed herein provide systems and methods for self-analysis and resolution of anomalies (and/or potential anomalies) by edge devices using a self-organizing infrastructure system.

In particular, in some cases, edge devices are actually equipped with enough computing resources to perform their own anomaly analysis and resolution. Additionally, certain edge devices may have close neighbors (e.g., within the same edge and/or on-premise environment, within one-hop from the edge device in a network context, or the like) having access to data (e.g., that store data) usable by these edge devices to perform their own anomaly analysis and resolution without having to rely on a centralized processing entity. The self-organizing infrastructure system of embodiments disclosed herein provide these edge devices with such insights such that these edge devices are able to reach an informed decision as to whether they are able to perform, whenever appropriate, their own analysis and resolution of anomalies without having to rely on a centralized processing entity.

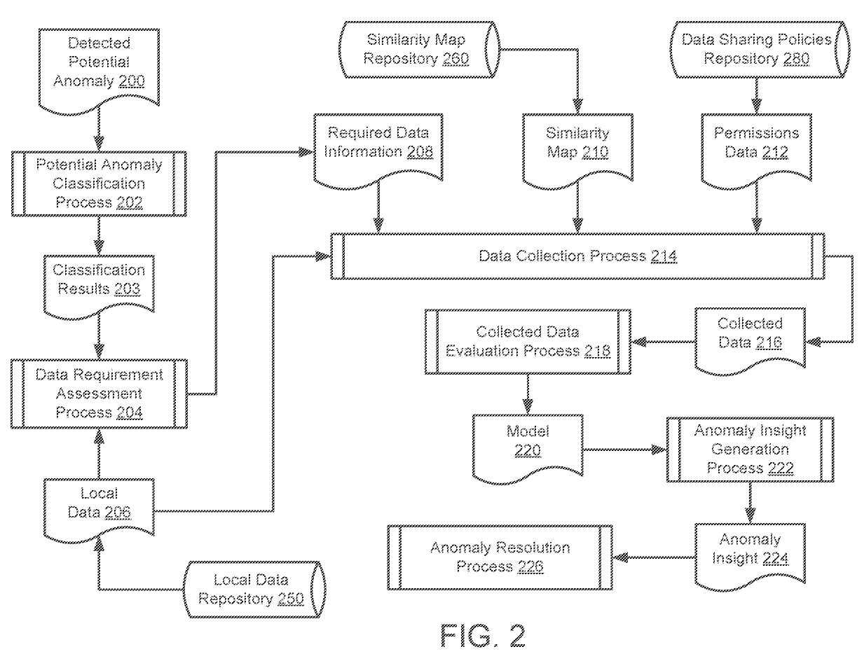

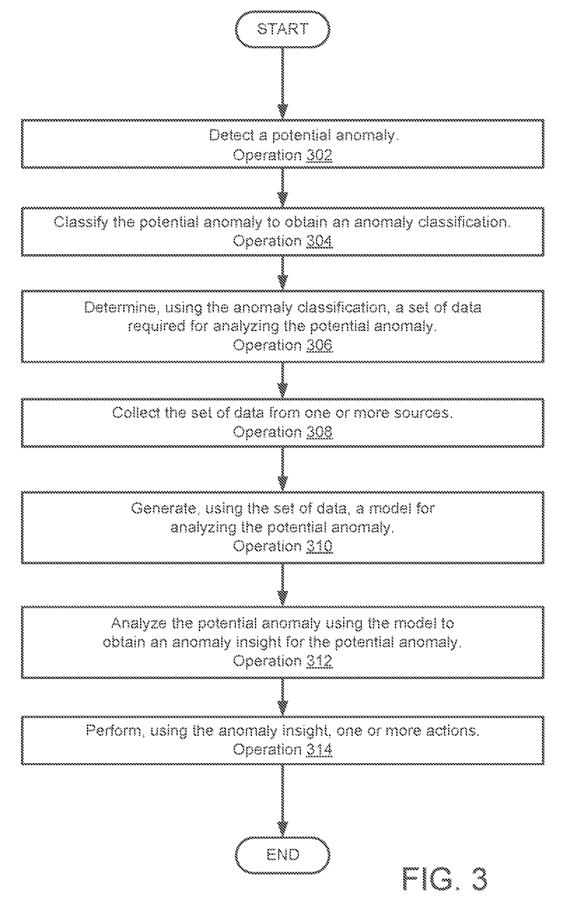

For example, an issue encountered by one edge device may have already been experienced by one or more neighboring devices (e.g., nodes) within the infrastructure. Such experiences by the other neighboring devices can advantageously be leveraged by an edge device in determining whether the edge device will be able to perform its own analysis and resolution of anomalies without having to rely on a centralized processing entity. Examples of such self-awareness and self-organization will be discussed in more detail below in reference to FIGS. 2 and 3.

Such ability for each device (e.g., node) within the infrastructure to access and apply insights from other nodes (provided through the self-organizing infrastructure system of embodiments disclosed herein) advantageously improves each node’s problem-solving efficacy, which directly improves the computer functionalities (e.g., problem-solving capabilities and functionalities) of such nodes.

Additionally, embodiments disclosed herein also improves the technical field of data processing system management within complex computing infrastructures. In particular, by allowing edge devices (and other nodes) to become more self-aware and by providing such edge devices with the capability to self-analyze and resolve anomalies, the above-discussed limitations associated with using a centralized processing entity for such anomaly analysis and resolution may advantageously be reduced or even completely eliminated.

For example, if an edge device is able to perform self-analysis and resolution of anomalies using its own data (or using data from locally connected devices within the same physical deployment), limitations such as high costs of data transfer and slower analysis and resolution of the anomaly due to high latency in data transmission lines can effectively be avoided.

In an embodiment, a computer-implemented method for managing anomaly analysis and resolution of a data processing system is provided. The computer-implemented method may include: detecting a potential anomaly of the data processing system; classifying the potential anomaly to obtain an anomaly classification; determining, using the anomaly classification, a set of data required for analyzing the potential anomaly and collect the set of data; generating, using the set of data, a model for analyzing the potential anomaly; analyzing the potential anomaly using the model to obtain an anomaly insight for the potential anomaly, the anomaly insight indicating whether the potential anomaly is a real anomaly that should be resolved or a false alarm; and performing, in response to the anomaly insight indicating that the potential anomaly is the real anomaly that should be resolved, one or more anomaly resolution actions to resolve the real anomaly and obtain an anomaly resolved data processing system.

Classifying the potential anomaly to obtain the anomaly classification may include: making an anomaly resolution determination to determine whether the potential anomaly can be analyzed using a simple solution or a complex solution. The simple solution is a non-machine learning based solution and the complex solution is a machine learning based solution, and a result of the anomaly resolution determination is indicated as the anomaly classification.

Determining the set of data required for analyzing the potential anomaly may include: making a data requirement assessment, using the result of the anomaly resolution determination and local data stored within a local data repository of the data processing system, to determine whether the data processing system has enough data stored locally to properly analyze the potential anomaly; in an event that a result of the data requirement assessment indicates that the data processing system does have enough data stored locally to properly analyze the potential anomaly, collecting the set of data comprises obtaining the set of data from the local data repository; and in an event that a result of the data requirement assessment indicates that the data processing system does not have enough data stored locally to properly analyze the potential anomaly, collecting the set of data comprises obtaining at least one portion of the set of data from remote sources.

Obtaining the at least one portion of the set of data from the remote sources may include: using a similarity map to identify the remote sources from which the at least one portion of the set of data is to be collected, the similarity map being stored in a similarity map repository of the data processing system.

The remote sources being one or more neighboring nodes to the data processing system within a computing infrastructure comprising a plurality of interconnected data processing systems, each of the plurality of interconnected data processing systems being a node within the computing infrastructure and the data processing system being one of the plurality of interconnected data processing systems.

The similarity map indicates which of the one or more neighboring nodes comprise infrastructural attributes that most closely matches an infrastructure of the data processing system and a spatial attribute of each of the one or more neighboring nodes in reference to a location of the data processing system within the computing infrastructure.

Obtaining the set of data from the remote sources may further include: identifying, after identifying the remote sources, a data sharing policy of each of the remote sources, wherein the set of data is obtained from the remote sources based on the data sharing policy of each of the remote sources.

The model is a machine learning based model or a non-machine learning based model, a type of the model that is generated being based on the anomaly classification, and anomaly classification indicating whether a simple solution or a complex solution will be required to analyze the potential anomaly.

The data processing system is an edge device among edge devices within a computing infrastructure comprising a centralized processing entity that is in charge of managing the anomaly analysis and resolution for all of the edge devices including the data processing system, the data processing system being configured to perform the method without interference from the centralized processing entity if the data processing system comprises sufficient computing resources to perform the method.

Generating the model for analyzing the potential anomaly may include: determining that computing resources of the data processing system is insufficient to generate the model locally; providing a model generation request to the centralized processing entity; and obtaining the model from the centralized processing entity.

A non-transitory media may include instructions that when executed by a processor cause the computer-implemented method to be performed.

A data processing system (e.g., an edge device) may include the non-transitory media and a processor, and may perform the computer-implemented method when the computer instructions are executed by the processor.

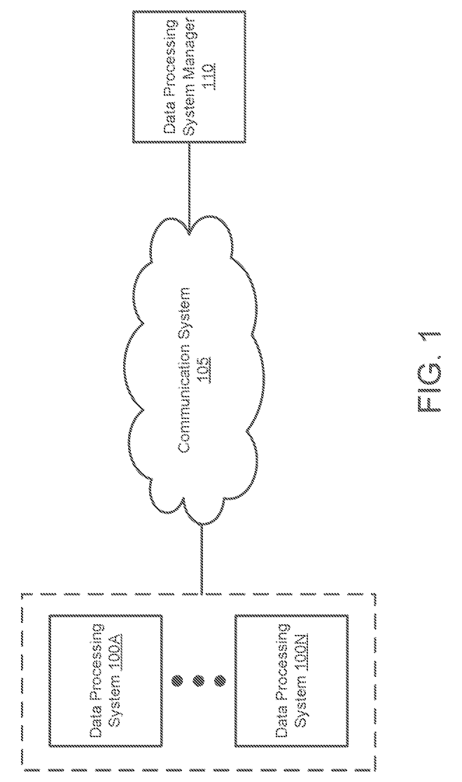

Turning to FIG. 1, a block diagram illustrating a system in accordance with an embodiment is shown. The system shown in FIG. 1 may provide computer-implemented services and may be managed by a data processing system manager 110 in order to provide the computer-implemented services. The system may include data processing systems 100A-100N. Data processing systems 100A-100N may include any number of computing devices that provide the computer-implemented services. For example, data processing systems 100A-100N may include one or more computing devices that may independently and/or cooperatively provide the computer-implemented services. For example, all, or a portion, of data processing systems 100A-100N may provide computer-implemented services to users and/or other computing devices operably connected to data processing systems 100A-100N.

The computer-implemented services may include any type and quantity of services including, for example, database services, instant messaging services, video conferencing services, prediction and/or inference generation services, machine learning (ML)/artificial intelligence (AI) related services, data science related services, etc. Different systems may provide similar and/or different computer-implemented services. To provide the computer-implemented services, data processing systems 100A-100N may host applications and/or computer-implemented models (e.g., large language models (LLMs), generative artificial intelligence (AI models), or the like) that provide these (and/or other) computer-implemented services. The applications and/or computer-implemented models may be hosted by one or more of data processing systems 100A-100N. For example, the applications may utilize (e.g., invoke use of, or the like) one or more backend components (e.g., the computer-implemented models, policies, backend applications, data and infrastructures, or the like) to provide the computer-implemented services.

To manage these data processing systems 100A-100N, the system of FIG. 1 may include a data processing system manager 110 configured as a centralized processing entity. In particular, the model adaptation manager 110 may be configured to receive telemetry (or the like) data from each data processing systems 100A-100N in order to manage system health, application and/or other software related deployments, physical deployments, updates, anomaly detection, anomaly analysis, anomaly resolution, and other similar services for these data processing systems 100A-100N.

Furthermore, when providing their functionality, data processing systems 100A-100N and/or model adaptation manager 110 may perform all, or a portion, of the method and/or actions shown in FIGS. 2-3.

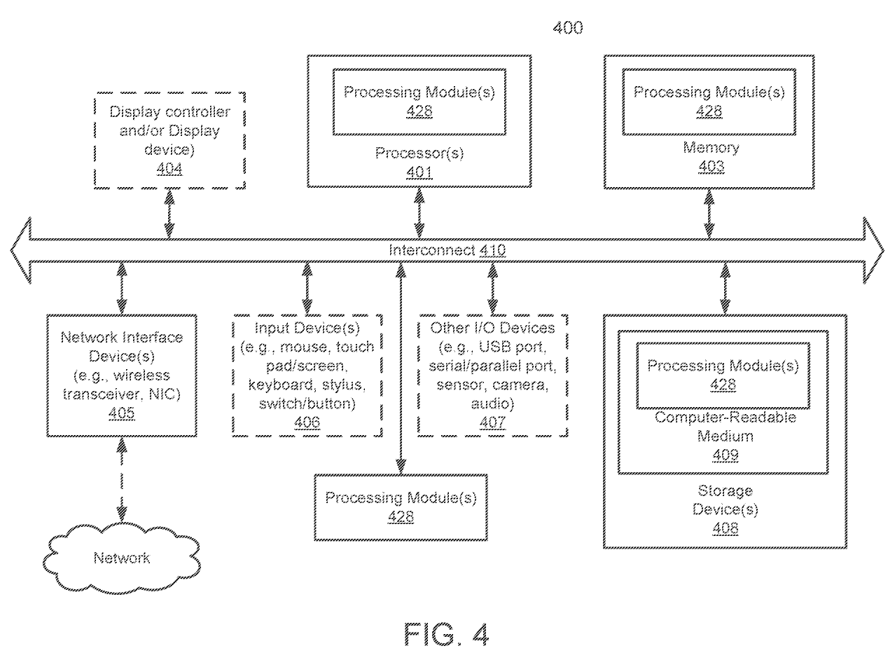

Data processing systems 100A-100N and data processing system manager 110 may be implemented using a computing device such as a host or server, a personal computer (e.g., desktops, laptops, and tablets), a “thin” client, a personal digital assistant (PDA), a Web enabled appliance, or a mobile phone (e.g., Smartphone), an embedded system, local controllers, and/or any other type of data processing device or system. For additional details regarding computing devices, refer to FIG. 4.

Any of the components illustrated in FIG. 1 may be operably connected to each other (and/or components not illustrated) with a communication system 105. In an embodiment, communication system 105 may include one or more networks that facilitate communication between any number of components. The networks may include wired networks and/or wireless networks (e.g., and/or the Internet). The networks may operate in accordance with any number and types of communication protocols (e.g., such as the internet protocol).

Additionally, while data processing systems 100A-100N are shown to be grouped together in FIG. 1, each of the data processing systems 100A-100N may be disposed at different physical locations (e.g., different physical deployments such as at an edge deployment, at an on-premise deployment, at a cloud deployment, or the like). Each physical location may have any number of the data processing systems 100A-100N. Data processing systems 100A-100N disposed at the same physical location may be connected to one another via a local area network (LAN) connection, and may be connected to other data processing systems 100A-100N at a different physical location via communication system 105.

Additionally, the data processing systems 100A-100N and data processing system manager 110 may be implemented to be part of a self-organized infrastructure system where each node (e.g., each data processing systems 100A-100N and data processing system manager 110) participates in a vast similarity map, which will be discussed in more detail below in reference to FIG. 2. The similarity map may indicate the interconnectedness of nodes based on spatial and infrastructural attributes, allowing nodes to effectively communicate and collaborate within the infrastructure.

Furthermore, in the self-organized infrastructure system, each node (e.g., each data processing system 100A-100N and data processing system manager 110) may have the following characteristics: (i) self-awareness and positioning where each node is aware of its location within the self-organized infrastructure system and can identify its relevant neighboring nodes based on spatial and infrastructural attributes; (ii) local data management where each node may autonomously record it’s own operational data, such as telemetry and application data, and understand the type and profile of these data; (iii) problem identification and resolution where when a data-driven analytics problem arises, each node may identify the problem type and determine the appropriate resolution (e.g., whether a simple threshold-based anomaly detection or a complex ML model will be required); (iv) selective data access where given (e.g., preset and/or predetermined) data access permissions, nodes may be able to filter and select usable data according to their requirements; and (v) local processing where upon obtaining the necessary data, nodes may be able to perform computations or model training locally, thus advantageously deriving insights or applications that can address the problem at hand without being negatively impacted by the above-discussed limitations associated with relying on a centralized processing entity to perform all of the heavy lifting (e.g., data processing).

While illustrated in FIG. 1 as included a limited number of specific components, a system in accordance with an embodiment may include fewer, additional, and/or different components than those illustrated therein.

To further clarify embodiments disclosed herein, a data flow diagram in accordance with an embodiment are shown in FIG. 2. In this diagram, flows of data and processing of data are illustrated using different sets of shapes. A first set of shapes (e.g., 200, 203, 206, 210, etc.) is used to represent data structures (e.g., files, documents, data packets, or the like), a second set of shapes (e.g., 202, 204, 218, 222 etc.) is used to represent processes performed using and/or that generate data, and a third set of shapes (e.g., 250, 260, 280, etc.) is used to represent large scale data structures such as databases.

The data flow diagram of FIG. 2 may be performed by any of the components (e.g., any of the data processing systems 100A-100N and the data processing system manager 110). In the description below, the data flow diagram of FIG. 2 will be discussed as being performed by a data processing system (e.g., 100A) of the data processing systems 100A-100N, and the data processing system may be configured as an edge device within the system (e.g., the system of FIG. 1).

As shown in FIG. 2, a data processing system (e.g., 100A) configured as, for example, an edge device may obtain detected potential anomaly 200. The detected potential anomaly may include any type of data (e.g., telemetry data, system metrics, operational data/metrics, system log data, application data, or the like) that can be gathered by the data processing system from itself (e.g., its own components and operations). For example, the detected potential anomaly 200 may include data indicative of an unusual spike in central processing unit (CPU) usage. The detected potential anomaly 200 may also include data indicative of other changes in other system metrics such as memory consumption or the like.

In embodiments, to be able to obtain the detected potential anomaly 200, the data processing system may be configured to locally manage its own data. In particular, the data processing system may be configured to autonomously manage its own operational data by gathering data such as: (i) telemetry data including performance metrics (e.g., CPU usage, memory consumption, network throughput, error logs, or the like); (ii) application data such as data generated by applications running on the data processing system (e.g., user activity logs, transaction records, sensor data, or the like). Other types of data about itself may be gathered by the data processing system without departing from the scope of embodiments disclosed herein.

Once gathered, the data processing system may classify and profile each of the gathered data by: (i) organizing data into categories based on type, source, usage, or the like to facility faster access; (ii) implement data retention policies or the like for determining how long different types of data are stored, ensuring that storage resources are used efficiently; (iii) ensuring that all stored data (or all sensitive data) is encrypted to protect sensitive information from unauthorized access; or the like. Other types of data classification and profiling (e.g., data processing) mechanisms may be used without departing from the scope of embodiments disclosed herein.

Once gathered and processed (e.g., classified and profiled), the data processing system may store the data in local data repository 250 as local data 206. In embodiments, the detected potential anomaly 200 may be obtained during such data gathering and processing processes (e.g., while the processes are being performed before the data is stored in local data repository 250) by the data processing system. Alternatively, or in addition, the detected potential anomaly 200 may be obtained from local data repository 250 at any time (e.g., during routine checks of the data within local data repository 250 or the like).

For example, in embodiments, the data processing system may be configured to detect irregularities within the gathered data and/or within the local data 206 stored in local data repository 250. For example, the data processing system may be configured to use statistical methods and/or machine learning models to detect unusual patterns in the data. Once detected, the observed and/or detected irregularities may be obtained as the detected potential anomaly 200.

Turning back to FIG. 2, the detected potential anomaly 200 may be ingested (e.g., by the data processing system) into potential anomaly classification process 202. In particular, as part of potential anomaly classification process 202, the data processing system may analyze the detected potential anomaly (e.g., using pre-stored algorithms, statistical models, ML models, sets of rules or policies, or the like) to assign an anomaly classification to the detected potential anomaly 200.

In embodiments, the anomaly classification may include: (i) a simple solution classification indicating that the detected potential anomaly 200 could potentially be analyzed without using machine learning (e.g., using a threshold-based alert analysis or the like); or (ii) a complex solution classification indicating that the detected potential anomaly 200 must be analyzed using machine learning. Although only two types of classifications are described here, other types and numbers of classifications may be used without departing from the scope of embodiments disclosed herein.

The anomaly classification generated from the potential anomaly classification process 202 may be included in classification results 203. Classification results 203 may be ingested by the data processing system into data requirement assessment process 204.

In embodiments, as part of data requirement assessment process 204, the data processing system may determine (e.g., assess, decide, or the like), using the anomaly classification, what processes (e.g., running local diagnostics without or without training (or even using) a machine learning model or the like) and data will be required to accurately analyze the detected potential anomaly 200.

To determine the necessary processes and data, data requirement assessment process 204 may also access the local data 206 stored in local data repository 250. In particular, data requirement assessment process 204 may be configured to determine, using the anomaly classification and the local data 206, whether the data processing system itself has enough data (e.g., in the form of local data 206) or whether the data processing system will need additional data (e.g., from other sources) to accurately analyze the detected potential anomaly 200. Any type of techniques and/or mechanisms (e.g., involving use of one or more using pre-stored algorithms, statistical models, ML models, sets of rules or policies, or the like) may be used by data processing system to reach this determination without departing from the scope of embodiments disclosed herein.

The results of the data requirement assessment process 204 (e.g., whether the data processing system itself has enough data (e.g., in the form of local data 206) or whether the data processing system will need additional data (e.g., from other sources) to accurately analyze the detected potential anomaly 200) may be included (e.g., stored) in required data information 208.

In embodiments, required data information 208 may be ingested into data collection process 214 where the data processing system is configured to collect the required data indicated in the required data information 208. Additionally, similarity map 210 and permissions data 212 may be ingested, along required data information 208, into data collection process 214.

In embodiments, the data processing system includes a similarity map repository 260 (that is implemented as a different or the same component as local data repository 250) that stores the similarity map 210.

Similarity map 210 may be compiled, updated, and distributed to each data processing system by the data processing system manger 110. Alternatively, or in addition to the above, each data processing system may also update each own locally stored similarity map 210.

In embodiments, similarity map 210 includes data that provides each data processing system (and the data processing system manger 110) with a multi-dimensional view of the computer infrastructure (e.g., the system of FIG. 1) in which the data processing system (and the data processing system manger 110) belongs. In particular, the similarity map 210 may include a spatial attribute (e.g., the physical or virtual location) of each node (e.g., each data processing systems 110A-110N and the data processing system manger 110) within the computer infrastructure and infrastructural attributes (e.g., processing power, memory, data types handled, computer-implemented services provided, or the like) of each node.

More specifically, the similarity map 210 may be a network topology map created in unison by all of the nodes making up the computer infrastructure (e.g., the system of FIG. 1). For example, data processing systems on the same LAN may ping and query one another (as well as network switches and routers) to produce such a network topology map. In particular, each node may share (e.g., with its neighboring nodes or the like) its system configuration data (e.g., configuration data on its components such as the CPU, memory, hard drive (HD) and/or solid state drive (SSD) storage, operating system (OS), or the like). Each node may also share a list of telemetry data (e.g., system temperature, CPU utilization, memory utilization, disk input/output (IO), or the like that the node is capable of collecting). Each node may further share its workload characteristics (e.g., average (AVG) temperature operating temperature range, AVG CPU utilization, max/min CPU utilization, memory utilization, disk utilization, or the like). Other data (e.g., data stored as local data 206 in each data processing system) may also be shared to create the similarity map 210 without departing from the scope of embodiments disclosed herein.

Using similarity map 210, each data processing system may advantageously gain self-awareness about its positioning within the infrastructure (e.g., the system of FIG. 1) and also gain awareness of other nodes (that it may be similar to) within the infrastructure. In particular, from the spatial and infrastructural attributes included in the similarity map 210, each data processing system may advantageously: (i) identify relevant neighbor nodes (e.g., by understanding its own position within the similarity map, a node can determine which other nodes are most relevant for collaboration based on proximity and resource availability); (ii) optimize communication (e.g., nodes can prioritize communication with closer or more resource-efficient neighbors, reducing latency and improving response times); (iii) enhance fault tolerance (e.g., by knowing its position and neighbors, a node can reroute tasks and data if a neighboring node fails, ensuring continuous operation); or the like.

Detailed examples of how the similarity map 210 is used during data collection process 214 will be described below in reference to the implementation examples of embodiments disclosed herein.

In embodiments, the data processing system includes a data sharing policies repository 280 (that is implemented as a different or the same component as local data repository 250 and/or the similarity map repository 260) that stores the permission data 212.

Additionally, the data processing system may be configured to include a data sharing agent (e.g., implemented in hardware, software, or a combination thereof such as an application processing interface (API) or the like) that compiles and manages the permissions data 212. The data sharing agent may also be configured to help each data processing system share data securely and efficiently with other nodes within the infrastructure.

In embodiments, the data sharing agent may be configured to have functions and capabilities such as: (i) authentication and authorization capabilities that ensure only authorized nodes are able to access data stored on other nodes (e.g., each node must authenticate itself to all other nodes from which it wishes to retrieve data (e.g., local data 206 of each node or the like) using secure tokens, certificates, or the like); (ii) query interface capabilities that allow nodes to request specific datasets from other nodes (e.g., queries may be tailored based on data type, time, range, or the like). (iii) data transfer protocol capabilities that utilize efficient and secure data transfer protocols (e.g., Hypertext Transfer Protocol Secure (HTTPS), gRPC Remote Procedure Calls (gRPC), or the like) to ensure data integrity and minimize transfer times; (iv) data format standardization capabilities that endure that shared data is sin a standardized format (e.g., JSON, XML) for easy parsing and integration by the receiving node; (v) rate limiting and quotas capabilities where rate limiting and data quotas may be implemented to prevent abuse and ensure fair resource usage across the network; (vi) logging and auditing capabilities that keep detailed logs of data sharing activities for auditing and troubleshooting purposes; or the like. The data sharing agent may have other functions and capabilities not discussed above without departing from the scope of embodiments disclosed herein.

In embodiments, the permissions data 212 may include the required permissions for accessing stored data from each node within the infrastructure. Given appropriate data access permissions (e.g., using the data stored in permissions data 212), nodes can filter and select (e.g., through interaction of a node’s data sharing agent with another node’s data sharing agent) usable data from other nodes or a central repository (e.g., maintained by data processing data manager 110).

For example, using permissions data 212, the data sharing agent of the data processing system may: (i) issue specific queries to retrieve data relevant to the problem a node is experiencing (e.g., the data listed in required data information 208), ensuring that only necessary data is transferred between nodes; (ii) ensuring that data sharing adheres to each node’s security and privacy policies, with permissions controlling which nodes can access which data; (iii) applying filters to select only the most relevant data (e.g., associated with the data listed in required data information 208), optimizing bandwidth usage and reducing unnecessary data processing; or the like).

Such mechanisms (e.g., selective access mechanisms) implemented by the data sharing agent using permissions data 212 advantageously allows the data processing system to gather precise data needed for analyzing detected potential anomaly 200 while minimizing overhead and maintaining security.

In embodiments, using required data information 208 in connection with similarity map 210, permissions data 212, and/or local data 206 from local data repository 250, data collection process 214 may generate collected data 216 (also referred to herein as “a set of data required for analyzing the potential anomaly”). Collected data 216 may include all data determined by the data processing system (e.g., using required data information 208 in connection with similarity map 210, permissions data 212, and/or local data 206 from local data repository 250) to be required for accurately analyzing (e.g., locally analyzing) the detected potential anomaly 200.

In embodiments, data processing system may ingest collected data 216 into collection data evaluation process 218 to generate one or more models 220. Depending on the anomaly classification determined in potential anomaly classification process 202, the model(s) 220 may be one or more ML-based models, one or more non-ML-based models, or a combination of both.

For example, if the detected potential anomaly 200 was classified as a simple solution classification, the model(s) 220 may be one or more non-ML-based models (e.g., statistical models, threshold-based models, or the like). Additional examples and details will be described below in reference to the implementation examples of embodiments disclosed herein.

In embodiments, data processing system may ingest the model(s) 220 and the detected potential anomaly 200 into anomaly insight generation process 222 to obtain (e.g., generate) an anomaly insight 224. In particular, the detected potential anomaly 200 may be used as input data and compared to the information included in the model(s) 220 to obtain the anomaly insight 224. Anomaly insight may indicate whether the detected potential anomaly 200 is an actual (e.g., real) anomaly (or a false alarm). An actual anomaly may be an irregularity that could cause the data processing system to fail in its entirety (or a specific component within the data processing system to fail and require replacement). Additional examples and details will be described below in reference to the implementation examples of embodiments disclosed herein.

In embodiments, collected data evaluation process 218 and anomaly insight generation process 222 may be part of a local processing mechanism performed by the data processing system. In particular, using the local processing mechanism, each node may leverage their computational capabilities to perform necessary data processing and model training locally including, for example: (i) statistical analysis for performing basic statistical analyses to gain insights from data quickly; (ii) machine learning including training and deploying machine learning models using the collected data 216 to predict trends, detect anomalies, or optimize performance; (iii) real-time processing for handling time-sensitive tasks directly on the node to ensure timely responses without waiting for central processing; or the like.

By enabling each node within the infrastructure, including all edge nodes (e.g., edge devices), to include such local processing mechanisms to process collected data based on each node’s self-awareness within the infrastructure, each node may advantageously provide faster insights and actions and reduce dependency on a central processing entity (thus removing each node from the limitations associated with relying on such a central processing entity).

In embodiments, data processing system may ingest anomaly insight 224 into an anomaly resolution process 226 to obtain (e.g., generate, determine, or the like) one or more anomaly resolution actions (e.g., to resolve the actual anomaly and obtain an anomaly resolved data processing system). Such anomaly resolution actions may include, for example: (i) notifying a user (e.g., admin) of the data processing system or of the system of FIG. 1 (e.g., through notification to the data processing system manager 110 of the anomaly insight 224; (ii) automatically perform one or more update/troubleshooting mechanisms to resolve the anomaly; (iii) do nothing is the detected potential anomaly 200 is not actually an anomaly; (iv) initiate automatic requests for part and/or component replacements (e.g., automatically transmit a request for a replacement CPU or SDD to be physically delivered to the location where the data processing system is at so that the replacement CPU or SDD can be installed into the data processing system, or the like); or the like.

Implementation examples of the processes discussed in the data flow diagram of FIG. 2 will now be discussed. A first implementation example will be described with respect to a simple case that does not require machine learning techniques for the anomaly analysis and resolution by the data processing system.

In particular, in the first implementation example, a data processing system detects a usual spike in its CPU usage. This spike is significant enough to warrant further investigation, but it is isolated, with no other apparent anomalies in other metrics.

Upon determining this spike (e.g., as detected potential anomaly 200), the data processing system (e.g., as part of potential anomaly classification process 202 and data requirement assessment process 204), may determine that it only needs CPU usage data from similar nodes to calculate a threshold (for comparing the spike to) in order to determine whether spike in the CPU usage is an actual anomaly.

Based on this determination (e.g., as part of data collection process 214), the data processing system can identify and query neighboring nodes (e.g., similar neighboring nodes) for their recent CPU usage data (while also ensuring that the data processing system has the necessary permissions to access such data). Said another way, the data processing system may retrieve CPU metrics from neighboring nodes with similar functions and configurations as the data processing system (e.g., using the self-awareness it has gained from the similarity map 210).

With the collected CPU data, the data processing system may generate (e.g., as part of collected data evaluation process 218) a non-ML-based model (e.g., by calculating a threshold for what should be normal CPU usage).

The data processing system may then (e.g., as part of anomaly insight generation process 222 and anomaly resolution process 226) compare the initially detected spike in CPU usage to the calculated threshold (e.g., included in the non-ML-based model) to determine whether the spike is an actual anomaly. For example, if the detected spike in CPU usage exceeds the calculated threshold, an alert may be triggered by the data processing system and the data processing system may perform other processes (e.g., reallocating resources and/or restarting services) to resolve the anomaly.

A second implementation example will now be described with respect to a complex case that does require use of one or more machine learning techniques for the anomaly analysis and resolution by the data processing system.

In the second implementation example, the data processing system detects an unusual spike in CPU usage. Along with the usual spike in CPU usage, the data processing system also detects changes in other system metrics, such as memory consumption and IOPS (Input/Output Operations Per Second). These combined changes (e.g., detected potential anomaly 200) suggest a more complex situation that may require comprehensive analysis to determine if the CPU spike is genuinely anomalous.

Based on such detected data, the data processing system determines (e.g., as part of potential anomaly classification process 202 and data requirement assessment process 204), that it needs a broader dataset, including additional metrics such as memory consumption and input/output operations per second (IOPS), to accurately identify the anomaly. It also seeks labeled data (if available as part of local data 206) that contains known alerts or issues to help train a more accurate model. If labeled data is not available, it collects the necessary data as unlabeled data.

In particular, the data processing system identifies and queries (e.g., as part of data collection process 214) neighboring nodes for a more extensive dataset, including CPU usage, memory consumption, and IOPS. It also requests any available labeled data indicating known anomalies or alerts. If labeled data is not available, it collects the necessary metrics as unlabeled data.

Once the data has been collected (e.g., as collected data 216), the data processing system may use a supervised approach or an unsupervised approach for generating one or more ML models (e.g., as model 220 using collected data evaluation process 218). For example, using the supervised approach (e.g., if labeled data is available), the data processing system uses the labeled data to train a supervised classification model (e.g., a decision tree or a neural network or the like). This model learns to distinguish between normal and anomalous behavior based on the combined metrics.

Using the unsupervised approach (e.g., if only unlabeled data is available), the data processing system applies unsupervised clustering techniques (e.g., k-means clustering, Density-Based Spatial Clustering of Applications with Noise (DBSCAN), or the like) to identify patterns and outliers in the data. This approach helps the node detect anomalies based on the clustering results.

In the supervised approach (and as part of anomaly insight generation process 222 and anomaly resolution process 226), the data processing system uses the trained classification model to evaluate the current metrics. If the model predicts an anomaly, the node triggers alerts or takes automated actions (e.g., performs the one or more anomaly resolution actions). In the unsupervised approach, the data processing system analyzes the clustering results to identify whether its current metrics fall into an anomalous cluster. If so, data processing system triggers alerts or takes automated actions to address the detected issue.

In embodiments, at any time during the processes discussed in the data flow diagram of FIG. 2, the data processing system may determine that it does not have the computational resources (e.g., enough limited computing resources) to complete the analysis of the detected potential anomaly. Such determination may be based, for example, on one or more predetermined set of rules set by the user or any other similar and/or suitable means. For example, if at potential anomaly classification process 202 the data processing system determines that ML models are required but (e.g., based on one or more pre-defined rules or policies, its own analysis of its system capabilities, or the like) it does not have sufficient limited computing resources to be able to train and use such ML models, data processing system may then provide all of the currently obtained results and data (e.g., classification results 203 and detected potential anomaly 200) along with is local data 206 to data processing system manager 110 for data processing system manager 110 to perform the anomaly analysis and resolution as the centralized processing entity.

As another example, during the collected data evaluation process 218, the data processing system may determine that its computing resources are insufficient for generating the model 220 locally. In such an event, the data processing system may generate and provide (e.g., transmit) a model generation request to a centralized processing entity (e.g., data processing system manager 110) and subsequently obtain the model from the centralized processing entity.

Any of the processes illustrated using the second set of shapes (shown in FIG. 2) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 3, a flow chart illustrating methods for managing a data processing system (namely, methods for managing anomaly analysis and resolution of a data processing system) in accordance with one or more embodiments are shown. The methods may be performed, for example, by any of the components of the system of FIG. 1, and/or other components not shown therein.

At Operation 302, as discussed above in reference to FIG. 2, a potential anomaly (e.g., detected potential anomaly 200) may be detected by a data processing system.

At Operation 304, as discussed above in reference to FIG. 2 (e.g., as part of the details of potential anomaly classification process 202), the potential anomaly may be classified to obtain an anomaly classification.

In particular, as part of Operation 304, an anomaly resolution determination may be made by the data processing system to determine whether the potential anomaly can be analyzed using a simple solution or a complex solution. In embodiments, the simple solution may be a non-machine learning based solution while the complex solution may be a machine learning based solution.

In embodiments, a result the anomaly resolution determination is indicated as (e.g., may be included as) the anomaly classification.

At Operation 306, as discussed above in reference to FIG. 2 (e.g., as part of the details of data requirement assessment process 204), the data processing system may determine a set of data required for analyzing the anomaly (e.g., as the required data information 208). And at Operation 308, as discussed above in reference to FIG. 2 (e.g., as part of the details of data collection process 214), the data processing system may collect the set of data from one or more sources (e.g., local and/or remote sources).

In particular, in embodiments, a data requirement assessment may be made (e.g., by the data processing system) using the result of the anomaly resolution determination and local data stored within a local data repository of the data processing system, to determine whether the data processing system has enough data stored locally to properly analyze the potential anomaly.

In an event that a result of the data requirement assessment indicates that the data processing system does have enough data stored locally to properly analyze the potential anomaly, the data processing system may collect the set of data by obtaining the set of data from the local data repository.

In an event that a result of the data requirement assessment indicates that the data processing system does not have enough data stored locally to properly analyze the potential anomaly, the data processing system may collect the set of data by obtaining at least one portion of the set of data from remote sources (while retrieving the other portion from local sources such as from local data repository 250).

In embodiments, a similarity map may be used to identify the remote sources from which the at least one portion of the set of data is to be collected. The similarity map may be stored in a similarity map repository of the data processing system.

The remote sources may be one or more neighboring nodes to the data processing system within a computing/computer infrastructure comprising a plurality of interconnected data processing systems where each of the plurality of interconnected data processing systems is a node within the computing infrastructure and the data processing system being one of the plurality of interconnected data processing systems.

In embodiments, the similarity map may include information that indicates which of the one or more neighboring nodes comprise infrastructural attributes that most closely matches an infrastructure of the data processing system and a spatial attribute of each of the one or more neighboring nodes in reference to a location of the data processing system within the computing infrastructure.

In embodiments, obtaining the set of data from remote sources may also include identifying, after identifying the remote sources, a data sharing policy of each of the remote sources where the set of data is obtained from the remote sources based on the data sharing policy of each of the remote sources.

At Operation 310, as discussed above in reference to FIG. 2 (e.g., as part of the details of collected data evaluation process 218), the data processing system may generate one or more models (e.g., model 220) for analyzing the potential anomaly.

At Operation 312, as discussed above in reference to FIG. 2 (e.g., as part of the details of anomaly insight generation process 222), the data processing system may analyze the potential anomaly using the model (e.g., the model generated in Operation 310) to obtain an anomaly insight (e.g., anomaly insight 224) for the potential anomaly.

At Operation 314, as discussed above in reference to FIG. 2 (e.g., as part of the details of anomaly resolution process 226), the data processing system may perform one or more actions (e.g., anomaly resolution actions, or the like) based on the anomaly insight.

The process of FIG. 3 may end following operation 314.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations.

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-408 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like.

More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing anomaly analysis and resolution of a data processing system, the method being performed by the data processing system and comprising:
detecting a potential anomaly of the data processing system;
classifying the potential anomaly to obtain an anomaly classification;
determining, using the anomaly classification, a set of data required for analyzing the potential anomaly and collect the set of data;
generating, using the set of data, a model for analyzing the potential anomaly;
analyzing the potential anomaly using the model to obtain an anomaly insight for the potential anomaly, the anomaly insight indicating whether the potential anomaly is a real anomaly that should be resolved or a false alarm; and
performing, in response to the anomaly insight indicating that the potential anomaly is the real anomaly that should be resolved, one or more anomaly resolution actions to resolve the real anomaly and obtain an anomaly resolved data processing system.

2. The method of claim 1, wherein classifying the potential anomaly to obtain the anomaly classification comprises:
making an anomaly resolution determination to determine whether the potential anomaly can be analyzed using a simple solution or a complex solution,
wherein the simple solution is a non-machine learning based solution and the complex solution is a machine learning based solution, and
wherein a result of the anomaly resolution determination is indicated as the anomaly classification.

3. The method of claim 2, wherein determining the set of data required for analyzing the potential anomaly comprises:
making a data requirement assessment, using the result of the anomaly resolution determination and local data stored within a local data repository of the data processing system, to determine whether the data processing system has enough data stored locally to properly analyze the potential anomaly;
in an event that a result of the data requirement assessment indicates that the data processing system does have enough data stored locally to properly analyze the potential anomaly, collecting the set of data comprises obtaining the set of data from the local data repository; and
in an event that a result of the data requirement assessment indicates that the data processing system does not have enough data stored locally to properly analyze the potential anomaly, collecting the set of data comprises obtaining at least one portion of the set of data from remote sources.

4. The method of claim 3, wherein obtaining the at least one portion of the set of data from the remote sources comprises:
using a similarity map to identify the remote sources from which the at least one portion of the set of data is to be collected, the similarity map being stored in a similarity map repository of the data processing system.

5. The method of claim 4, wherein the remote sources being one or more neighboring nodes to the data processing system within a computing infrastructure comprising a plurality of interconnected data processing systems, each of the plurality of interconnected data processing systems being a node within the computing infrastructure and the data processing system being one of the plurality of interconnected data processing systems.

6. The method of claim 5, wherein the similarity map indicates which of the one or more neighboring nodes comprise infrastructural attributes that most closely matches an infrastructure of the data processing system and a spatial attribute of each of the one or more neighboring nodes in reference to a location of the data processing system within the computing infrastructure.

7. The method of claim 4, wherein obtaining the set of data from the remote sources further comprises:
identifying, after identifying the remote sources, a data sharing policy of each of the remote sources, wherein the set of data is obtained from the remote sources based on the data sharing policy of each of the remote sources.

8. The method of claim 1, wherein the model is a machine learning based model or a non-machine learning based model, a type of the model that is generated being based on the anomaly classification, and anomaly classification indicating whether a simple solution or a complex solution will be required to analyze the potential anomaly.

9. The method of claim 1, wherein the data processing system is an edge device among edge devices within a computing infrastructure comprising a centralized processing entity that is in charge of managing the anomaly analysis and resolution for all of the edge devices including the data processing system, the data processing system being configured to perform the method without interference from the centralized processing entity if the data processing system comprises sufficient computing resources to perform the method.

10. The method of claim 9, wherein generating the model for analyzing the potential anomaly comprises:
determining that computing resources of the data processing system is insufficient to generate the model locally;
providing a model generation request to the centralized processing entity; and
obtaining the model from the centralized processing entity.

11. A non-transitory machine-readable medium having instructions stored therein, which when executed by a processor, cause the processor to perform operations for managing anomaly analysis and resolution of a data processing system, the operations comprising:
detecting a potential anomaly of the data processing system;
classifying the potential anomaly to obtain an anomaly classification;
determining, using the anomaly classification, a set of data required for analyzing the potential anomaly and collect the set of data;
generating, using the set of data, a model for analyzing the potential anomaly;
analyzing the potential anomaly using the model to obtain an anomaly insight for the potential anomaly, the anomaly insight indicating whether the potential anomaly is a real anomaly that should be resolved or a false alarm; and
performing, in response to the anomaly insight indicating that the potential anomaly is the real anomaly that should be resolved, one or more anomaly resolution actions to resolve the real anomaly and obtain an anomaly resolved data processing system.

12. The non-transitory machine-readable medium of claim 11, wherein classifying the potential anomaly to obtain the anomaly classification comprises:
making an anomaly resolution determination to determine whether the potential anomaly can be analyzed using a simple solution or a complex solution,
wherein the simple solution is a non-machine learning based solution and the complex solution is a machine learning based solution, and
wherein a result of the anomaly resolution determination is indicated as the anomaly classification.

13. The non-transitory machine-readable medium of claim 12, wherein determining the set of data required for analyzing the potential anomaly comprises:
making a data requirement assessment, using the result of the anomaly resolution determination and local data stored within a local data repository of the data processing system, to determine whether the data processing system has enough data stored locally to properly analyze the potential anomaly;
in an event that a result of the data requirement assessment indicates that the data processing system does have enough data stored locally to properly analyze the potential anomaly, collecting the set of data comprises obtaining the set of data from the local data repository; and
in an event that a result of the data requirement assessment indicates that the data processing system does not have enough data stored locally to properly analyze the potential anomaly, collecting the set of data comprises obtaining at least one portion of the set of data from remote sources.

14. The non-transitory machine-readable medium of claim 13, wherein obtaining the at least one portion of the set of data from the remote sources comprises:
using a similarity map to identify the remote sources from which the at least one portion of the set of data is to be collected, the similarity map being stored in a similarity map repository of the data processing system.

15. The non-transitory machine-readable medium of claim 14, wherein the remote sources being one or more neighboring nodes to the data processing system within a computing infrastructure comprising a plurality of interconnected data processing systems, each of the plurality of interconnected data processing systems being a node within the computing infrastructure and the data processing system being one of the plurality of interconnected data processing systems.

16. A data processing system, comprising:
a processor; and
a memory coupled to the processor to store instructions, which when executed by the processor, cause the processor to perform operations for managing anomaly analysis and resolution, the operations comprising:
detecting a potential anomaly of the data processing system;
classifying the potential anomaly to obtain an anomaly classification;
determining, using the anomaly classification, a set of data required for analyzing the potential anomaly and collect the set of data;
generating, using the set of data, a model for analyzing the potential anomaly;
analyzing the potential anomaly using the model to obtain an anomaly insight for the potential anomaly, the anomaly insight indicating whether the potential anomaly is a real anomaly that should be resolved or a false alarm; and
performing, in response to the anomaly insight indicating that the potential anomaly is the real anomaly that should be resolved, one or more anomaly resolution actions to resolve the real anomaly and obtain an anomaly resolved data processing system.

17. The data processing system of claim 16, wherein classifying the potential anomaly to obtain the anomaly classification comprises:
making an anomaly resolution determination to determine whether the potential anomaly can be analyzed using a simple solution or a complex solution,
wherein the simple solution is a non-machine learning based solution and the complex solution is a machine learning based solution, and
wherein a result of the anomaly resolution determination is indicated as the anomaly classification.

18. The data processing system of claim 17, wherein determining the set of data required for analyzing the potential anomaly comprises:
making a data requirement assessment, using the result of the anomaly resolution determination and local data stored within a local data repository of the data processing system, to determine whether the data processing system has enough data stored locally to properly analyze the potential anomaly;
in an event that a result of the data requirement assessment indicates that the data processing system does have enough data stored locally to properly analyze the potential anomaly, collecting the set of data comprises obtaining the set of data from the local data repository; and
in an event that a result of the data requirement assessment indicates that the data processing system does not have enough data stored locally to properly analyze the potential anomaly, collecting the set of data comprises obtaining at least one portion of the set of data from remote sources.

19. The data processing system of claim 18, wherein obtaining the at least one portion of the set of data from the remote sources comprises:
using a similarity map to identify the remote sources from which the at least one portion of the set of data is to be collected, the similarity map being stored in a similarity map repository of the data processing system.

20. The data processing system of claim 19, wherein the remote sources being one or more neighboring nodes to the data processing system within a computing infrastructure comprising a plurality of interconnected data processing systems, each of the plurality of interconnected data processing systems being a node within the computing infrastructure and the data processing system being one of the plurality of interconnected data processing systems.
